(19) United States
(12) Patent Application Publication
(10) Pub. No.: US 2008/0070605 A1
(43) Pub. Date: Mar. 20, 2008

(54) Music message service method and apparatus for mobile terminal

(75) Inventor: Kwan Su Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/783,492

(22) Filed: Apr. 10, 2007

(30) Foreign Application Priority Data
Sep. 19, 2006 (KR) 2006-90351

(51) Int. Cl. H04Q 7/20

(52) U.S. Cl. 455/466

(57) ABSTRACT

A music message service method and apparatus for a mobile terminal are disclosed. A music message transmitting method in a music message service includes: storing in a mobile terminal at least one scale information set having a plurality of musical notes, wherein the musical notes have assigned audible frequencies and are mapped to input key values; selecting one of the stored scale information sets; displaying mappings between input keys and musical notes using the selected scale information set; creating a music message by inputting input keys to enter desired music data, wherein the music data is converted by a receiving mobile terminal into sounds using a scale information set identical to the selected scale information set; appending a scale identifier identifying the selected scale information set to the created music message; and transmitting the music message to the receiving mobile terminal.

### PRIORITY

This application claims the benefit under 35 U.S.C. §119(a) of Korean Patent Application filed in the Korean Intellectual Property Office on Sep. 19, 2006 and assigned Serial No. 2006-90351, the entire disclosure of which is hereby incorporated by reference.

### BACKGROUND OF THE INVENTION

1. Field of the Invention

The present invention relates generally to a mobile terminal and, more particularly, to a music message service method and apparatus for a mobile terminal wherein particular character data in a text message is converted into sound data and played as a melody.

2. Description of the Related Art

A portable terminal can be easily carried by a user, and can store and execute various application programs. Accordingly, the portable terminals are widely utilized in various ways and across diverse fields. In particular, mobile communication terminals enabling voice communication while in motion have become increasingly popular.

Mobile communication terminals provide not only voice communication services but also message services. In a voice communication service, a call connection is established between two mobile communication terminals. In a message service, a message composed at a sending mobile communication terminal is transmitted via a message service center of a mobile communication system to a recipient mobile communication terminal, without establishment of a call connection.

Such a message service includes a voice message service for delivering recorded speech information, and a text message service for delivering character information. Because the use of a text message service does not make a loud noise, the text message service is suitable for places or situations in which silence is encouraged, and has become an essential feature for numerous users.

However, a conventional text message service is mainly used to transmit and receive a message including only a string of characters or emoticons composed of character combinations, and is insufficient for satisfying the diverse needs of users.

### SUMMARY OF THE INVENTION

The present invention has been made in view of the above problems, and an aspect of the present invention is to provide a music message service method and apparatus for a mobile terminal that satisfies the diverse needs of users and attracts interests of users by improving utilization of message services.

In accordance with an exemplary embodiment of the present invention, there is provided a music message service A music message transmitting method in a music message service for a mobile terminal, comprising: storing in a mobile terminal at least one scale information set having a plurality of musical notes, wherein the musical notes have assigned audible frequencies and are mapped to input key values; displaying mappings between input keys on a mobile terminal and musical notes using the selected scale information set; and creating a music message by selecting input keys on the mobile terminal to enter desired music data, wherein the music data is converted by a receiving mobile terminal into sounds using a scale information set that corresponds to the selected scale information set.

In accordance with an aspect of the present invention, the mobile terminal stores a plurality of scale information sets and the method further comprises selecting one of the plurality of scale information sets;

In accordance with an aspect of the present invention, the method further comprises: identifying the selected scale information set in the created music message; and transmitting the music message to the receiving mobile terminal.

In accordance with an aspect of the present invention, the identifying step comprises appending a scale identifier identifying the selected scale information set to the created music message.

In accordance with an aspect of the present invention, the scale information set is identical to the selected scale information set.

In accordance with an exemplary embodiment of the present invention, there is provided a music message service apparatus for a mobile terminal, including: a memory unit for storing a scale information set and music messages composed using the scale information set, wherein the scale information set has a plurality of musical notes, each musical note having an assigned audible frequency and a mapped input key value; a key input unit for inputting input key values mapped to musical notes of the scale information set for music message composition; an audio processor for generating sounds; a radio frequency (RF) unit for music message transmission and reception; a display unit for displaying mappings between input keys and musical notes, and message windows for music message composition and reading; a tone generator for controlling the audio processor to generate sounds using the scale information set; and a controller for controlling exchange of signals between the memory unit, key input unit, audio processor, RF unit, display unit, and tone generator.

In accordance with another exemplary embodiment of the present invention, there is provided a music message transmitting method in a music message service for a mobile terminal, including: storing in a mobile terminal at least one scale information set having a plurality of musical notes, wherein the musical notes have assigned audible frequencies and are mapped to input key values; selecting one of the stored scale information sets; displaying mappings between input keys and musical notes using the selected scale information set; creating a music message by inputting input keys to enter desired music data, wherein the music data is converted by a receiving mobile terminal into sounds using a scale information set identical to the selected scale information set; appending a scale identifier identifying the selected scale information set to the created music message; and transmitting the music message to the receiving mobile terminal.

In accordance with another exemplary embodiment of the present invention, there is provided a music message receiving method in a music message service for a mobile terminal, including: receiving a message; extracting, if the received message is a music message, a scale identifier and music data from the received music message, wherein the scale identifier identifies a scale information set having a plurality of musical notes, each musical note having an assigned audible frequency and a mapped input key value; and producing sounds corresponding to the extracted music data using the scale information set identified by the extracted scale identifier.

In accordance with another exemplary embodiment of the present invention, there is provided a music message service method for a mobile terminal, including: selecting, by a sending mobile terminal, a scale information set having a plurality of musical notes, wherein the musical notes have assigned audible frequencies and are mapped to input key values; creating a music message by inputting input keys to enter desired music data, wherein the music data is converted by a receiving mobile terminal into sounds using a scale information set identical to the selected scale information set, appending a scale identifier identifying the selected scale information set to the created music message, and transmitting the music message to the receiving mobile terminal; receiving, by the receiving mobile terminal, the music message from the sending mobile terminal, and extracting the scale identifier and music data from the received music message; and producing sounds corresponding to the extracted music data using the scale information set identified by the extracted scale identifier.

### BRIEF DESCRIPTION OF THE DRAWINGS

The above and other aspects, features and advantages of exemplary embodiments of the present invention will be more apparent from the following description in conjunction with the accompanying drawings, in which:

FIG. 1 illustrates a configuration of a music message service system capable of providing a music message service according to an exemplary embodiment of the present invention;

FIG. 2 illustrates an exemplary configuration of a sending mobile terminal of the system of FIG. 1;

FIG. 3 illustrates an exemplary configuration of a receiving mobile terminal of the system of FIG. 1;

FIG. 4 is a flow chart illustrating a transmission procedure in a music message service method according to an exemplary embodiment of the present invention;

FIG. 5 illustrates a screen representation of a menu for handling music messages according to an exemplary embodiment of the present invention;

FIG. 6 illustrates a screen representation of a digit input window, and mappings between keypad input keys and musical notes according to an exemplary embodiment of the present invention;

FIG. 7 illustrates a screen representation of a text edit window to input character and numeric data according to an exemplary embodiment of the present invention;

FIG. 8 is a flow chart illustrating a reception procedure in a music message service method according to an exemplary embodiment of the present invention;

FIG. 9 illustrates a screen representation of a music message containing character data according to an exemplary embodiment of the present invention; and

FIG. 10 illustrates a screen representation of a music message without character data according to an exemplary embodiment of the present invention. Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention relates to delivery of music data using a text message service provided for a mobile terminal. The music data is represented by strings of characters mapped to corresponding notes of a musical scale. The musical scale may be a pentatonic scale, a seven-note scale, an extended or modified one of these scales, or any other scale.

For the purpose of description, a sending mobile terminal and a receiving mobile terminal are described as separate entities. However, a mobile terminal of the present invention may be realized so as to act both as a sending mobile terminal capable of composing and sending a music message and as a receiving mobile terminal capable of receiving and playing a music message.

Various kinds of input keys, such as numeric keys, alphanumeric keys, or combinations of numeric and special character keys, may be mapped to musical notes for composition of music messages.

Although, for the purpose of description, a mobile communication terminal is described as an example of a mobile terminal of the present invention, the present invention is not limited to a mobile communication terminal. The mobile terminal of the present invention is a terminal that can deliver music message services, and may be any information and communication device and multimedia device, such as a mobile communication terminal, digital broadcast terminal, personal digital assistant, smart phone, international mobile telecommunications 2000 (IMT 2000) terminal, wideband code division multiple access (WCDMA) terminal, universal mobile telecommunications system (UMTS) terminal, and so on. The mobile terminal may also be applied to applications using such devices.

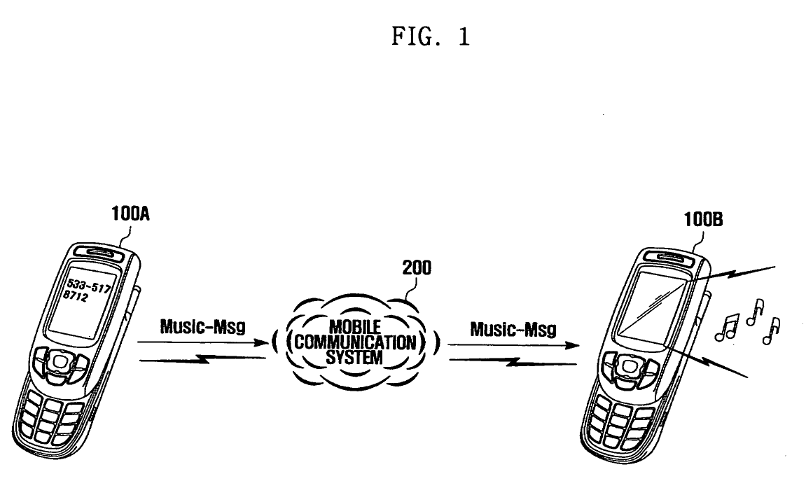

FIG. 1 illustrates a configuration of a music message service system capable of providing a music message service according to an exemplary embodiment of the present invention.

Referring to FIG. 1, the music message service system includes a mobile communication system 200, a sending mobile terminal 100A for composing and transmitting a music message to the mobile communication system 200, and a receiving mobile terminal 100B for receiving and playing the music message from the sending mobile terminal 100A. It is to be understood that a single mobile terminal can operate as a sending mobile terminal 100A for making outgoing calls (e.g., sending a music message) and as a receiving mobile terminal 100B for receiving calls which may include music messages.

To use a music message service, a sending user selects a music message menu of the sending mobile terminal 100A, composes a text message by inputting a string of digits through numeric input keys mapped to corresponding musical notes of a musical scale in a pre-stored scale information set, and transmits the composed text message as a music message via the mobile communication system 200 to the receiving mobile terminal 100B.

The scale information set stores information on mappings between numeric input keys and musical notes, and sound data of various musical instruments such as a piano, a drum and an organ. The scale information set may be pre-stored in a mobile terminal during a manufacturing process, or downloaded from an external provider if necessary. The scale information set may further include dual-tone multi-frequency (DTMF) tone data.

DTMF tones are used in telephones for tone dialing, and can be generated by inputting input keys of a telephone keypad. DTMF tones correspond to combinations of four low frequencies (697, 770, 852 and 941 Hz) and three high frequencies (1209, 1336 and 1477 Hz). Twelve DTMF tones are mapped to input keys of numbers and/or characters (e.g., digits 0-9, ‘*’ and ‘#’) in a telephone keypad.

The receiving mobile terminal 100B receives a music message, extracts a string of digits from the received music message, and plays the extracted digit string as a continuous melody using a pre-stored scale information set. The scale information set corresponds to that of the sending mobile terminal 100A for correct processing of music messages.

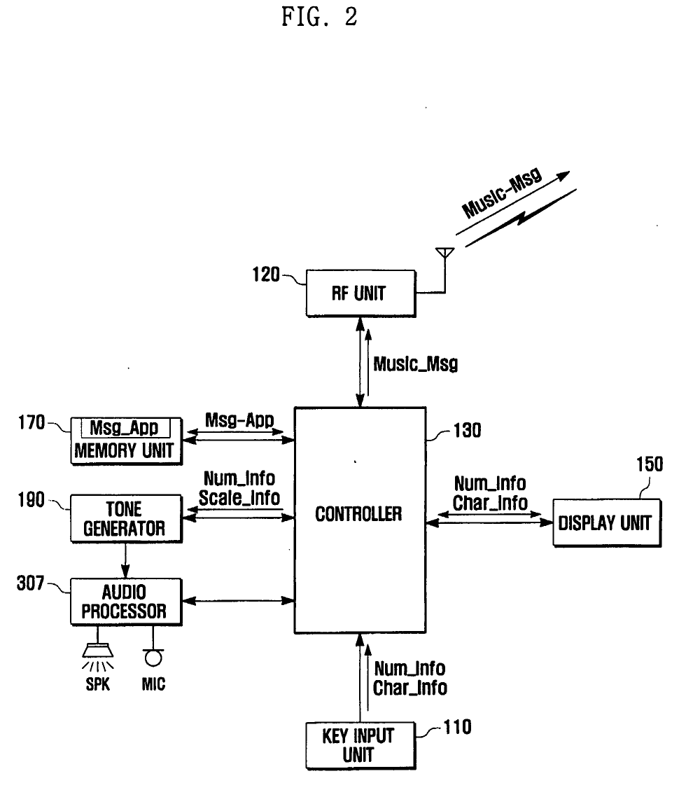

FIG. 2 illustrates a configuration of the sending mobile terminal 100A in accordance with an exemplary embodiment of the present invention. FIG. 2 also illustrates signals exchanged between internal components in accordance with an exemplary embodiment of the present invention.

Referring to FIG. 2, the sending mobile terminal 100A includes a radio frequency (RF) unit 120, a memory unit 170, a key input unit 110, a display unit 150, an audio processor 307, a tone generator 190, and a controller 130.

The RF unit 120 performs wireless communication operations for transmitting user data to another mobile terminal and connecting to an external Web server to receive content therefrom. The RF unit 120 includes an RF transmitter for upconverting the frequency of a signal to be transmitted and amplifying the signal, and an RF receiver for low-noise amplifying a received signal and downconverting the frequency of the signal. In particular, the RF unit 120 transmits a music message via the mobile communication system 200 to a receiving mobile terminal 100B, under the control of the controller 130.

The memory unit 170 stores application programs for processing functions related to music message services, received music messages, and at least one scale information set utilized for playing digit strings contained in music messages as melodies.

The memory unit 170 preferably includes a program memory section and a data memory section. The program memory section stores an operating system for booting and operating the sending mobile terminal 100A, application programs such as for multimedia content reproduction, photographing, sound file playing, and image and video playing, and a message application program Msg-App for converting digit strings in a received music message into sounds. When the sending mobile terminal 100A activates a function requested by the user, a corresponding application program is executed to perform the requested function under the control of the controller 130.

The data memory section of the memory unit 170 stores data generated from operation of the sending mobile terminal 100A, and temporarily stores music messages composed at the sending mobile terminal 100A. A music message to be stored in the data memory section preferably comprises one or more of a text data part composed of characters, a numeric data part to be played as sounds using an associated scale information set, and a scale data part indicating a scale information set matched to the numeric data part. The scale data part may include real tone data corresponding to the numeric data part. However, when the sending mobile terminal 100A and receiving mobile terminal 100B use identical scale information sets, the scale data part preferably includes only an identifier of a scale information set actually used in the message for message size reduction and efficiency. For example, each scale identifier can correspond to a scale information set for a particular musical instrument such as a piano, orgel or pipe organ. Accordingly, a scale information set itself need not be included in the scale data part of a music message for message size reduction and efficiency.

The key input unit 110 includes numeric, character and function input keys for inputting numeric and character information and for setting various functions, respectively. The function input keys may include direction, side and shortcut input keys associated with assigned functions. The key input unit 110 inputs an input key from the user for setting and controlling a desired function of the sending mobile terminal 100A, and sends the corresponding input key signal to the controller 130. In particular, for composition of a music message, the user enters text data through character and special input keys of the key input unit 110, and numeric data to be converted into sounds through numeric input keys thereof.

The display unit 150 displays various menus, information from the user (e.g., text entered by the user via the input keys), and information provided to the user. In particular, when the user decides to transmit a music message, the display unit 150 displays a menu for music message selection, a message edit window for music message composition, and an input key-to-note map table for inputting a digit string to be converted into sounds. The display unit 150 may include a panel having liquid crystal display (LCD) devices. If the panel has a touch screen capability, the display unit 150 can also act as an input means.

The audio processor 307 reproduces a received audio signal through a speaker SPK, and processes an audio signal such as a voice signal from a microphone MIC. In particular, when the user composes a music message, the audio processor 307 is configured to operate with the tone generator 190 to generate sounds corresponding to musical notes mapped preferably uniquely to input numeric input keys according to a preset scale information set. The scale information set may include individual sound frequencies, a tone index to a selected musical instrument or to electronic sound data such as DTMF tones by way of a few examples. Thus, the user can hear sounds corresponding to a string of digits input by numeric input keys during composition of a music message.

The tone generator 190 opens a selected one of the scale information sets stored in the memory unit 170, extracts a frequency value associated with an input numeric input key from the selected scale information set, and sends the extracted frequency value to the audio processor 307 to produce of a sound corresponding to the input numeric input key. A scale information set may be pre-stored in a mobile terminal during a manufacturing process, or downloaded from an external provider if necessary. When a scale information set includes DTMF tone data and the user decides to use DTMF tones, the tone generator 190 generates DTMF tones using a DTMF tone generator.

The controller 130 controls the overall operation of the sending mobile terminal 100A, and exchange of signals between the internal components thereof. The controller 130 may include a modulator/demodulator (modem) and a coder/decoder (codec). In particular, the controller 130 controls the tone generator 190 to open a selected scale information set, to extract a frequency value associated with an input numeric input key, and to send the extracted frequency value to the audio processor 307.

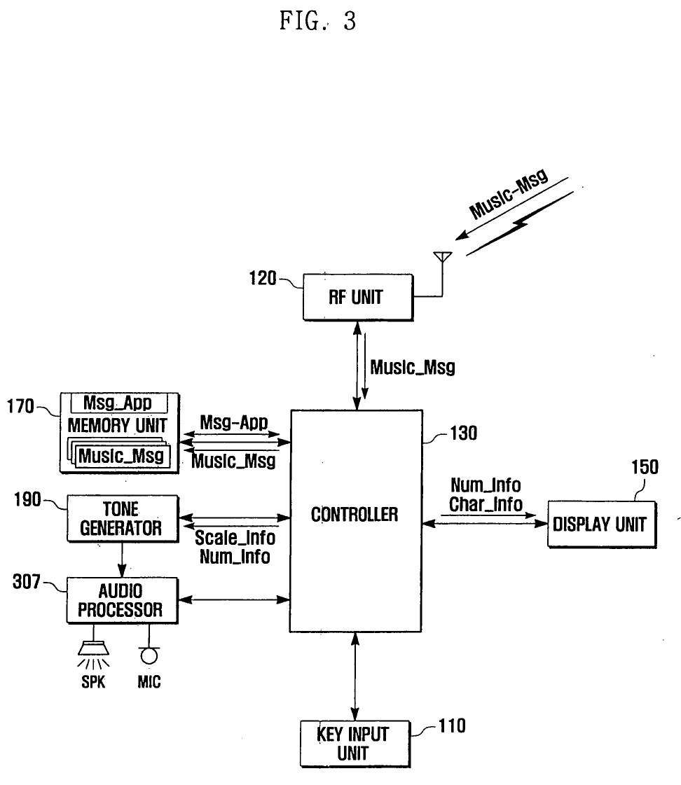

FIG. 3 illustrates a configuration of the receiving mobile terminal 100B. FIG. 3 also illustrates signals exchanged between internal components.

As the configuration of the receiving mobile terminal 100B is identical to that of the sending mobile terminal 100A of FIG. 2, a repeated description of the configuration is omitted from the following description of the receiving mobile terminal 100B.

Referring to FIG. 3, the receiving mobile terminal 100B includes an RF unit 120, a memory unit 170, a key input unit 110, a display unit 150, an audio processor 307, a tone generator 190, and a controller 130.

The RF unit 120 connects to the mobile communication system 200, and receives a music message from a sending mobile terminal 100A, under the control of the controller 130.

The memory unit 170 stores received music messages temporarily or semi-permanently, and scale information sets necessary for playing digit strings in music messages as melodies. The memory unit 170 preferably includes a program memory section and a data memory section.

The program memory section in the memory unit 170 stores a message application program (Msg-App) for handling messages. The message application program is an application program that supports a short message service (SMS), multimedia message service (MMS) and a music message service, and is activated and displays a necessary window for composition, transmission, reception or reading of a message.

The data memory section of the memory unit 170 stores data generated from operation of the receiving mobile terminal 100B, received music messages temporarily or semi-permanently, and scale information sets. For a particular received music message, the scale information set corresponds to (e.g., is identical to) that of the sending mobile terminal 100A. A scale information set may be pre-stored in a mobile terminal during a manufacturing process, or downloaded from an external provider if necessary.

The key input unit 110 includes numeric, character and function input keys for inputting numeric and character information and for setting various functions. The key input unit 110 generates an input key signal for reading a received music message.

The display unit 150 displays a window for reading a received music message. The display unit 150 may include a panel having liquid crystal display (LCD) devices. If the panel has a touch screen capability, the display unit 150 can also act as an input means.

The audio processor 307 generates sounds corresponding to a string of digits contained in a received music message. The audio processor 307 can generate sounds of various musical instruments, and electronic sounds such as DTMF tones.

The tone generator 190 opens a scale information set stored in the memory unit 170 to produce sounds corresponding to a string of digits contained in a received music message. The opened scale information set corresponds to (e.g., is identical to) that used by the sending mobile terminal 100A to compose the received music message. Thereto, preferably, the sending mobile terminal 100A inserts an identifier of a utilized scale information set into a composed music message, and transmits the music message containing the scale identifier to the receiving mobile terminal 100B, which then opens a scale information set identified by the scale index. After opening the scale information set, the tone generator 190 in the mobile terminal 100B extracts frequency values associated with individual digits of the digit string in the received music message from the opened scale information set, and sends the extracted frequency values to the audio processor 307 for sound reproduction through a speaker SPK. A scale information set may be pre-stored in a mobile terminal during a manufacturing process, or downloaded from an external provider if necessary. When a scale information set includes DTMF tone data and identical DTMF tone data is utilized by the sending mobile terminal 100A, the tone generator 190 in the mobile terminal 100B generates DTMF tones corresponding to a digit string using a DTMF tone generator.

The controller 130 controls the overall operation of the receiving mobile terminal 100B, and exchange of signals between the internal components thereof. The controller 130 may include a modulator/demodulator (modem) and a coder/decoder (codec). In particular, the controller 130 controls the tone generator 190 to open a scale information set matched to a received music message, to extract frequency values associated with a digit string in the received music message from the opened scale information set, and to send the extracted frequency values to the audio processor 307 for outputting sounds to the user.

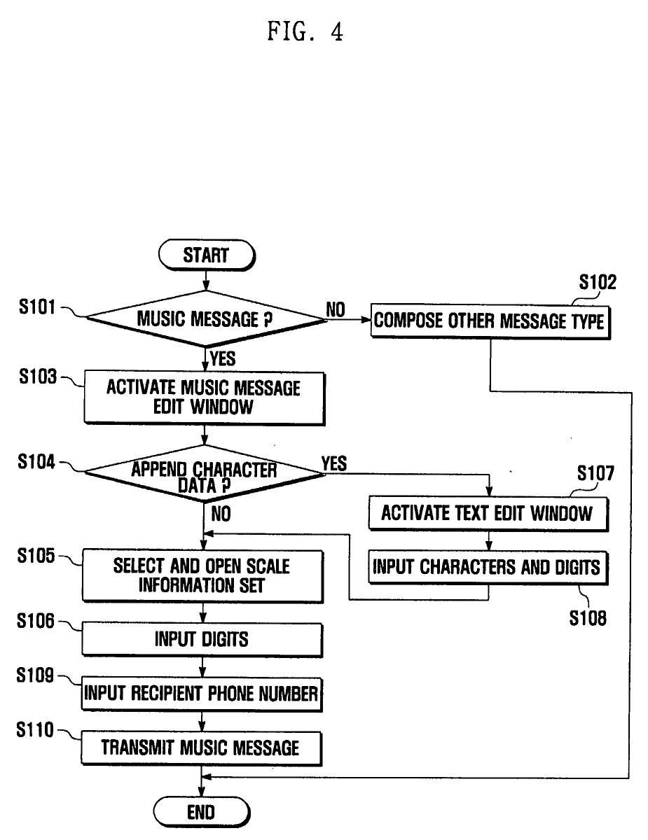

Hereinafter, a music message service method of the present invention is described in connection with FIGS. 4 to 10.

FIG. 4 is a flow chart illustrating a transmission procedure in the music message service method according to an exemplary embodiment of the present invention. The transmission procedure is performed by a sending mobile terminal 100A.

Referring to FIG. 4, when the user inputs an input key, the sending mobile terminal 100A activates a menu window, and determines whether a music message menu item is selected (S101). As illustrated in FIG. 5, the menu window includes a message menu item (e.g., “New MuM Msg”) for composing an SMS message or MMS message, and a music message menu item for composing a music message.

If a music message menu item is not selected, for example if a message menu item for an SMS message or MMS message is selected, the controller 130 displays a message edit window for an SMS message or MMS message (S102).

If a music message menu item is selected, the controller 130 displays a music message edit window (S103). The music message edit window is a base window for music message composition, and preferably includes a list of available scale information sets and a digit input window for inputting digits associated with music data.

The controller 130 in the mobile terminal 100A requests the user to decide whether to insert character data into a music message to be composed (S104). If the user decides not to insert character data, the user selects a scale information set, and the controller 130 opens the selected scale information set (S105). The controller 130 activates the digit input window, and the user then inputs a string of digits using the digit input window (S106).

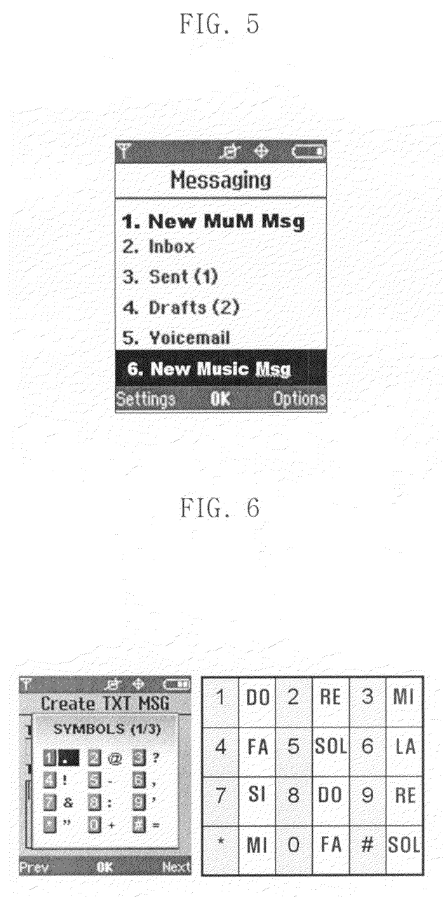

FIG. 6 illustrates a screen representation of a digit input window, and mappings between musical notes and keypad input keys. In a scale information set, relationships between numeric input keys, numeric input key values, musical notes, and frequency values are defined.

At step S106, after opening the selected scale information set, when the user activates the input keys of the key input unit 110 specified in the opened scale information set, input key values associated with the input keys are input to the music message and corresponding sounds are produced. During input of a digit string, the user can adjust the length of a sound corresponding to a particular digit by appending a special character such as ‘-’ to the digit. For example, in an extended string “5--5567-87-8”, the sound of ‘5--’ becomes two times longer than that of ‘5’. Unlike repetition of an identical sound, the sound lengthened by ‘-’ is preferably continuous and without pause.

Returning to FIG. 4, if the user decides at step S104 to insert character data into the music message, the controller 130 activates a text edit window (S107), and the user then inputs both characters and numeric data (S108).

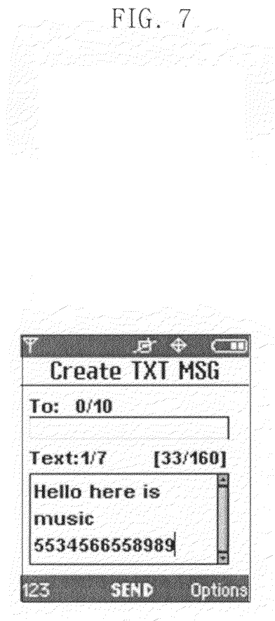

FIG. 7 illustrates a screen representation of a text edit window to input character and numeric data. At step S108, character data and numeric data can be input separately using separate input boxes, or input together using a single input box. When a music message containing both character data and numeric data is received, the receiving mobile terminal 100B can regard the numeric data whose number of digits is greater than or equal to a preset value, as music data to be played. The controller 130 in the mobile terminal 100A preferably inserts only an identifier of the used scale information set, not the scale information set itself, to the music message to reduce the size of the music message.

The user activates a recipient phone number window, and inputs a recipient phone number through the key input unit 110 (S109).

After completion of music message composition, the sending mobile terminal 100A transmits the composed music message to the mobile communication system 200 (S110). Before transmission of the music message, the user can check both production of sounds and textual contents of the music message using a preview or pre-hear feature.

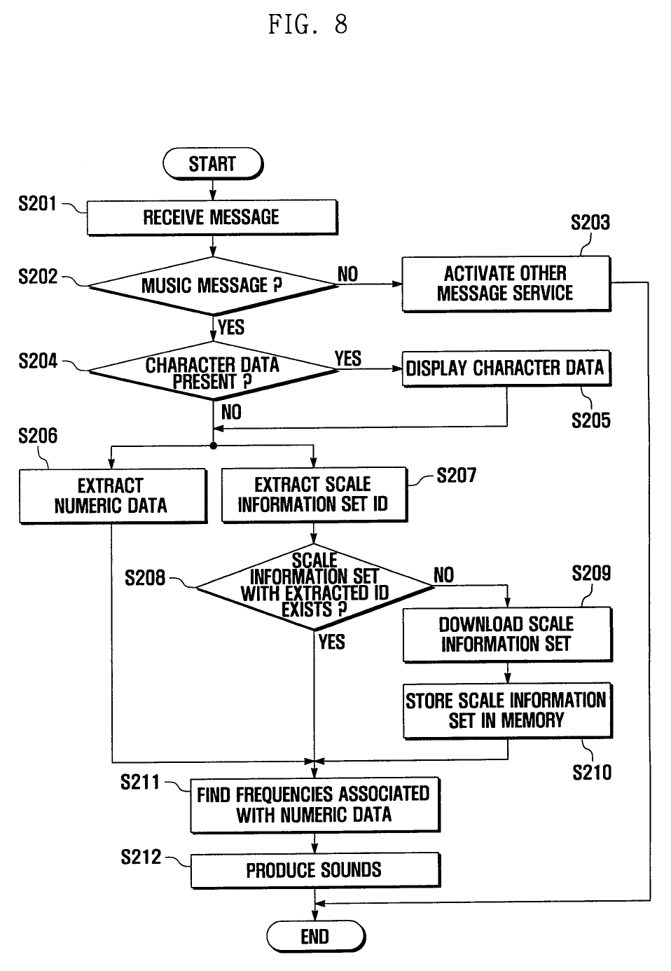

FIG. 8 is a flow chart illustrating a reception procedure in the music message service method according to another exemplary embodiment of the present invention. The reception procedure is performed by a receiving mobile terminal 100B.

Referring to FIG. 8, when a message is received (S201), the receiving mobile terminal 100B determines whether the received message is a music message (S202).

If the received message is not a music message, for example if it is an SMS or MMS message, the controller 130 in the mobile terminal 100B activates a corresponding message window and displays the received message (S203).

If the received message is a music message, the controller 130 in the mobile terminal 100B determines whether character data is present in the music message (S204). If character data is present in the music message, the controller 130 displays the character data in a text display window (S205).

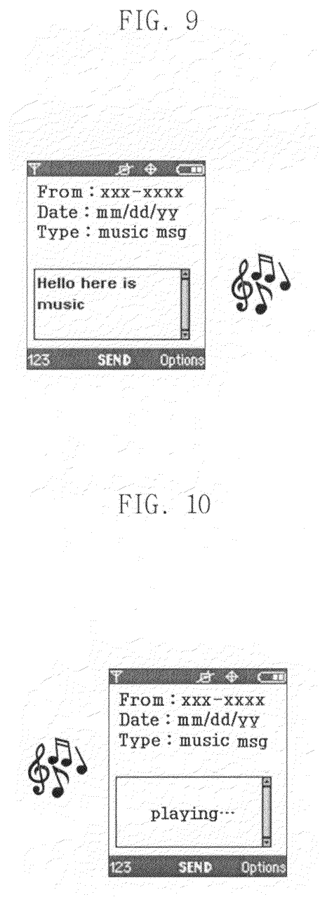

FIG. 9 illustrates a screen representation of a music message containing character data. As illustrated in FIG. 9, at step S205, the character data in the music message is displayed together with message reception information such as a sender, reception date and time, and message type.

If character data is not present in the music message at step S204, the controller 130 in the mobile terminal 100B extracts numeric data from the music message (S206), and also extracts an identifier of a scale information set utilized in the music message (S207).

The controller 130 in the mobile terminal 100B determines whether a scale information set identified by the extracted identifier is stored in the receiving mobile terminal 100B (S208). If the scale information set is not stored, the controller 130 downloads the scale information set identified by the extracted identifier from an external service provider via the mobile communication system 200 (S209), and stores the downloaded scale information set in the memory unit 170 (S210).

The controller 130 in the mobile terminal 100B finds frequency values corresponding to the numeric data from the music message using the scale information set (S211), and produces sounds using the retrieved frequency values (S212). If character data is present in the music message, the character data may be displayed in the text display window simultaneously with sound production.

FIG. 10 illustrates a screen representation of a music message without character data. As illustrated in FIG. 10, at step S212, if character data is not present in the music message, the controller 130 may display a status indicator (for example, “playing . . . ”) in the text display window. Message reception information may be displayed above the text display window. If character data is not present in the music message, the text display window may be not activated. Further, the numeric data converted to sounds may be displayed in the display unit 150.

As apparent from the above description, the present invention provides a music message service method and apparatus for a mobile terminal, wherein a mobile terminal transmits a music message containing numeric data denoting a music segment; and another mobile terminal receives the music message and produces sounds corresponding to the numeric digits using, for example, DTMF tones. As a result, a music message service is provided using a standard text message service, thereby heightening message-service utilization and attracting the interest of users.

While preferred embodiments of the present invention have been shown and described in this specification, it will be understood by those skilled in the art that various changes or modifications of the embodiments are possible without departing from the spirit and scope of the invention as defined by the appended claims.

What is claimed is:

1. A music message transmitting method in a music message service for a mobile terminal, comprising:
storing in a mobile terminal at least one scale information set having a plurality of musical notes, wherein the musical notes have assigned audible frequencies and are mapped to input key values;
displaying mappings between input keys on a mobile terminal and musical notes using the selected scale information set; and
creating a music message by selecting input keys on the mobile terminal to enter desired music data, wherein the music data is converted by a receiving mobile terminal into sounds using a scale information set that corresponds to the selected scale information set.

2. The music message transmitting method of claim 1, wherein the mobile terminal stores a plurality of scale information sets and further comprising selecting one of the plurality of scale information sets;

3. The music message transmitting method of claim 1, further comprising:
identifying the selected scale information set in the created music message; and
transmitting the music message to the receiving mobile terminal.

4. The music message transmitting method of claim 1, wherein the identifying step comprises appending a scale identifier identifying the selected scale information set to the created music message.

5. The music message transmitting method of claim 1, wherein the scale information set is identical to the selected scale information set.

6. The music message transmitting method of claim 1, wherein one of the scale information sets includes data regarding dual tone multi-frequency (DTMF) tones.

7. The music message transmitting method of claim 1, wherein the input keys are a combination of alphabetic input keys, numeric input keys and special character input keys.

8. The music message transmitting method of claim 1, wherein the music data comprises an input key value indicating a sound length.

9. The music message transmitting method of claim 1, wherein the music message further comprises character data to be displayed on a display unit of the receiving mobile terminal.

10. A music message receiving method in a music message service for a mobile terminal, comprising:
receiving a message;
extracting, if the received message is a music message, a scale identifier and music data from the received music message, wherein the scale identifier identifies a scale information set having a plurality of musical notes, each musical note having an assigned audible frequency and a mapped input key value; and
producing sounds corresponding to the extracted music data using the scale information set identified by the extracted scale identifier.

11. The music message receiving method of claim 10, further comprising downloading, if the scale information set identified by the extracted scale identifier is not present in the receiving mobile terminal, the scale information set identified by the extracted scale identifier from an external provider.

12. The music message receiving method of claim 10, further comprising displaying character data other than the music data on a display unit.

13. The music message receiving method of claim 10, wherein the music data comprises numeric input key values mapped uniquely to the musical notes of the scale information set.

14. The music message receiving method of claim 10, wherein the music data comprises an input key value indicating a sound length.

15. The music message receiving method of claim 10, wherein the scale information set includes data regarding dual tone multi-frequency (DTMF) tones.

16. A music message service method for mobile terminals, comprising:
selecting, by a sending mobile terminal, a scale information set having a plurality of musical notes, wherein the musical notes have assigned audible frequencies and are mapped to input key values;
creating a music message by inputting input keys to enter desired music data, wherein the music data is converted by a receiving mobile terminal into sounds using a scale information set corresponding to the selected scale information set, identifying the selected scale information set in the created music message, and transmitting the music message to the receiving mobile terminal;
receiving, by the receiving mobile terminal, the music message from the sending mobile terminal, and extracting the scale identifier and music data from the received music message; and
producing sounds corresponding to the extracted music data using the scale information set identified by the extracted scale identifier.

17. The music message service method of claim 16, wherein the scale information set used by the receiving mobile terminal is identical to the selected scale information set.

18. The music message service method of claim 16, wherein the creating step comprises appending a scale identifier identifying the selected scale information set to the created music message.

19. The music message service method of claim 16, wherein the scale information set includes data regarding dual tone multi-frequency (DTMF) tones.

20. The music message service method of claim 16, further comprising downloading, if the scale information set identified by the extracted scale identifier is not present in the receiving mobile terminal, the scale information set identified by the extracted scale identifier from an external provider.

21. The music message service method of claim 16, further comprising displaying character data other than the music data in the received music message on a display unit of the receiving mobile terminal.

22. The music message service method of claim 16, wherein the extracted scale identifier identifies the scale information set to be used by the receiving mobile terminal for converting the extracted music data into sounds.

23. A music message service apparatus for a mobile terminal, comprising:
a memory unit for storing a scale information set and music messages composed using the scale information set, wherein the scale information set has a plurality of musical notes, each musical note having an assigned audible frequency and a mapped input key value;
a key input unit for inputting input key values mapped to musical notes of the scale information set for music message composition;
an audio processor for generating sounds;
a radio frequency (RF) unit for music message transmission and reception;
a display unit for displaying mappings between input keys and musical notes, and message windows for music message composition and reading;
a tone generator for controlling the audio processor to generate sounds using the scale information set; and
a controller for controlling exchange of signals between the memory unit, key input unit, audio processor, RF unit, display unit, and tone generator.

24. The music message service apparatus of claim 23, wherein the scale information set includes data regarding dual tone multi-frequency (DTMF) tones.

25. The music message service apparatus of claim 24, further comprising:
a DTMF tone generator for generating DTMF tones; and
a DTMF tone receiver for receiving a DTMF signal.

26. The music message service apparatus of claim 23, wherein the key input unit comprises an input key for generating an input key value indicating a sound length.
